(19) United States
(12) Patent Application Publication
(10) Pub. No.: US 2014/0177041 A1
(43) Pub. Date: Jun. 26, 2014

(54) OUTSIDE MIRROR ASSEMBLY FOR VEHICLE

(71) Applicants: Kia Motors Corporation, Seoul (KR); Hyundai Motor Company, Seoul (KR)

(72) Inventors: Jin Hee Lee, Seoul (KR); Nak Kyoung Kong, Seongnam (KR); Hyun Sub Kim, Seoul (KR); Jung Tae Park, Gyeongsan (KR); Byoung Gon Choi, Daegu (KR)

(73) Assignees: KIA MOTORS CORPORATION, Seoul (KR); HYUNDAI MOTOR COMPANY, Seoul (KR)

(21) Appl. No.: 13/901,987

(22) Filed: May 24, 2013

(30) Foreign Application Priority Data
Dec. 24, 2012 (KR) 10-2012-0152455

(51) Int. Cl. B60R 1/08

(52) U.S. Cl. CPC B60R 1/081
USPC 359/359; 359/850

(57) ABSTRACT

An outside minor assembly for a vehicle is provided, which can prevent inflow of foreign matter such as dust, and improve durability by providing a structure in which an integrated minor surrounds a holder. The outside minor assembly includes a blind zone minor and an outside mirror that are integrally injection-molded using a plastic material, and a dust cover that is bent backward from frames of the blind zone minor, where the outside minor surrounds a circumferential surface of a holder.

### CROSS-REFERENCE TO RELATED APPLICATION

This application claims under 35 U.S.C. §119(a) the benefit of Korean Patent Application No. 10-2012-0152455 filed Dec. 24, 2012, the entire contents of which are incorporated herein by reference.

### BACKGROUND

(a) Technical Field

The present invention relates to an outside mirror assembly for a vehicle. More particularly, the present invention relates to an outside mirror assembly configured to prevent inflow of foreign matter such as dust or other contaminants, and improve durability by providing a structure in which an integrated minor obtained by integrating a blind zone minor and an outside minor surrounds a holder.

(b) Description of the Related Art

As is well known in the art, an outside minor of a vehicle through which a driver can see other vehicles located to the sides and/or rear of the vehicle is mounted at a front end position on the outer surface of a front door. However, the driver cannot see a dead zone beyond the driver's viewing angle through the outside minor.

Accordingly, a separate blind zone minor may be adhered to the outside minor so that the driver can see the dead zone, or a blind zone minor may be combined with the outside minor.

The structure of a conventional outside minor assembly having a blind zone minor combined therewith will be described with reference to FIGS. 6 to 8 (RELATED ART).

A blind zone minor 202 and an outside minor 204, which are made of a glass material, are separately provided and adhered to the front of a glass holder 210 in a state in which the blind zone minor 202 and the outside minor 204 are divided. Here, the glass holder 210 is mounted in a body 200 of the outside minor assembly so that the angle of the glass holder 210 can be adjusted.

To this end, first and second adhesion surfaces 211 and 212 are formed on the front surface of the glass holder 210 in a state in which the first and second adhesion surfaces 211 and 212 are divided. Here, the outside minor 204 is adhered to the first adhesion surface 211, and the blind zone minor 202 is adhered to the second adhesion surface 212. A divider surface 213 that is a portion of the glass holder 210 is formed to protrude at the boundary portion between the first and second adhesion surfaces 211 and 212. The divider surface 213 functions to distinguish the first adhesion surface 211 from the second adhesion surface 212.

Thus, the outside minor 204 is adhered to the first adhesion surface 211 of the glass holder 210 by the medium of a double-faced adhesive tape 220, and the blind zone minor 202 is also adhered to the second adhesion surface 212 by the medium of the double-faced adhesive tape 220.

In this case, as shown in FIG. 8, a cover end 214 vertically bends forward to surround the circumferential surfaces of the outside minor 204 and the blind zone minor 202, and is integrally formed around the frame of the glass holder 210.

However, since the curvature of the outside minor and the blind zone minor is different from that of the glass holder, there occurs a phenomenon that the outside minor or the blind zone minor may separate from the glass holder in spite of the adhesion of the double-faced adhesive tape.

Particularly, as shown in FIG. 8, a gap between the cover end 214 of the glass holder 210 and the circumferential surface of the outside minor 204 and a gap between the cover end 214 of the glass holder 210 and the circumferential surface of the blind zone minor 202 are exposed to the outside of the body 200 of the outside assembly, and therefore, external dust may penetrate into each gap, thereby decreasing the adhesion of the double-face adhesive tape 202.

As the gap between the divider surface 213 of the glass holder 210 and the circumferential surface of the outside minor 204 and the gap between the divider surface 213 of the glass holder 210 and the circumferential surface of the blind zone minor 202 are exposed to the outside of the body 200 as shown in FIGS. 6 and 7, penetration of the external dust is accelerated, thereby decreasing the adhesion of the double-face adhesive tape 202.

If penetration of the dust continues, the adhesion of the double-faced adhesive tape is considerably decreased after a certain time elapses. As a result, the outside mirror or the blind zone mirror may be separated from the glass holder.

### SUMMARY OF THE DISCLOSURE

The present invention has been made in an effort to solve the above-described problems associated with the related art. Accordingly, the present invention provides an outside mirror assembly for a vehicle, in which a blind zone mirror and an outside mirror are integrally injection-molded using a plastic material, and a dust cover that is bent backward from frames of the blind zone mirror and the outside minor surrounds a circumferential surface of a holder. In particular, the present invention can be carried out by performing injection molding of a structure in which the dust cover is integrally formed with the blind zone mirror and the outside mirror, so that the penetration of dust is blocked in advance, thereby preventing separation of the blind zone minor and the outside mirror from the holder.

In one aspect, the present invention provides an outside minor assembly for a vehicle, including an integrated minor having a blind zone minor and an outside mirror that are integrally injection-molded, and a dust cover being bent backward is integrally formed with frames of the blind zone minor and the outside mirror. In particular, when the integrated mirror is adhered to the front surface of a holder by the medium of a double-faced adhesive tape, the dust cover of the integrated minor surrounds a circumferential surface of the holder.

In an exemplary embodiment, the integrated minor including the blind zone minor and the outside minor may be formed by coating a reflective material for reflecting the appearance of an object on the surface of a body made of a plastic material.

In another exemplary embodiment, the integrated minor including the blind zone minor and the outside minor may be formed by sequentially coating a UV hard coating layer, a first SiO₂ coating layer, a chrome coating layer and a second SiO₂ coating layer on the surface of the body made of a polycarbonate (PC) material.

In still another exemplary embodiment, a divider fastening groove may be formed at a boundary portion between the blind zone minor and the outside minor of the integrated minor, and a divider for distinguishing the blind zone minor from the outside minor may be inserted and fastened into the divider fastening groove.

In yet another exemplary embodiment, a hook may be inserted and fastened into the divider fastening groove of the integrated minor, the hook being integrally formed on the rear surface of the divider.

In still yet another exemplary embodiment, a receiving groove may be further formed at a portion corresponding to the divider fastening groove of the integrated minor on a front surface of the holder, the receiving groove configured to allow a rear protruding groove of the divider fastening groove to be inserted therein.

Other aspects and exemplary embodiments of the invention are discussed herein.

Certain advantages of the present invention are described as follows.

According to the present invention, a blind zone minor and an outside minor can be integrally injection-molded using a plastic material, and a reflective material for reflecting the appearance of an object may be coated on the surfaces of the blind zone mirror and the outside minor, thereby providing an integrated minor. Thus, unlike conventional minors made of a glass material, it is possible to prevent breakdown of the integrated mirror and to improve durability.

Particularly, a dust cover bent backward is integrally injection-molded with a frame of the integrated mirror so as to surround a circumferential surface of a holder. Thus, it is possible to block a gap that may form between the integrated mirror and the holder from being exposed to the outside.

Further, any such gap between the integrated minor and the holder is not exposed to the outside, so that it is possible to block the penetration of dust in advance and to maintain the adhesion of a double-faced adhesive tape for adhering the integrated mirror to the holder.

Further, a separate divider may be inserted into a boundary portion between the blind zone minor and the outside minor of the integrated mirror, so that a driver can clearly distinguish the blind zone minor from the outside mirror. Accordingly, the driver can clearly distinguish an object shown in the outside mirror from an object in a dead zone, which is shown in the blind zone mirror, thereby improving the driver's visibility.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exploded perspective view showing an outside minor assembly for a vehicle according to an embodiment of the present invention;

FIG. 2 is an assembled perspective view showing the outside minor assembly according to the embodiment of the present invention;

FIG. 3 is a sectional view taken along the line A-A of FIG. 2;

FIG. 4 is a sectional view taken along the line B-B of FIG. 2;

FIG. 5 is a sectional view showing a state in which the outside mirror assembly is mounted to the vehicle according to the embodiment of the present invention; and

FIGS. 6 to 8 (RELATED ART) are views showing a conventional outside minor assembly for a vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

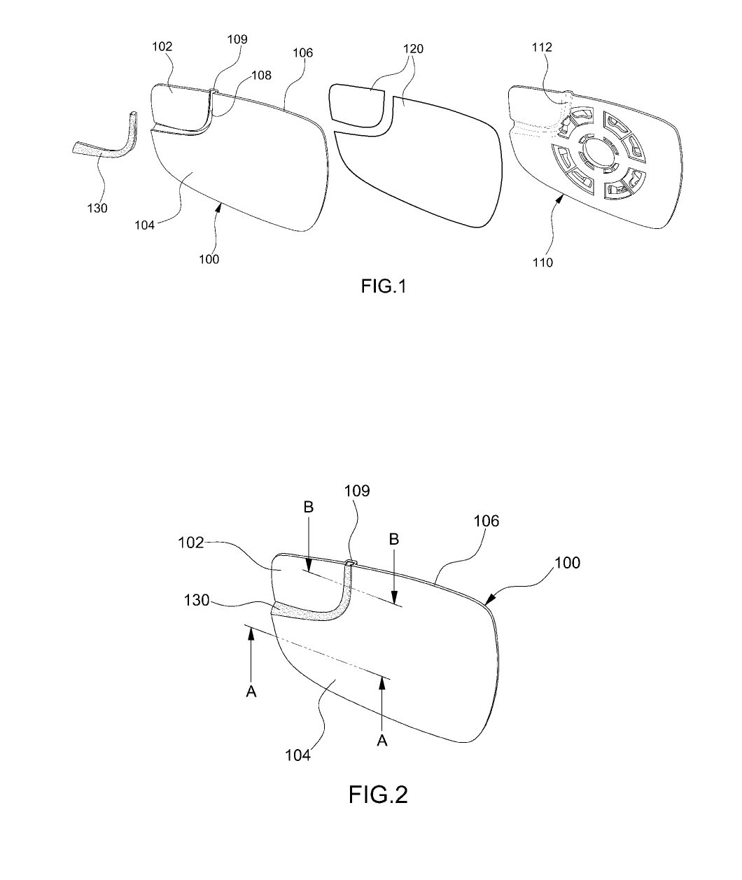

As shown in FIGS. 1 and 2, reference numeral 100 represents an integrated mirror.

The integrated minor 100 according to an embodiment of the present invention is provided as a structure in which a blind zone minor 102 and an outside minor 104 are integrally injection-molded using a plastic material, and a reflective material for reflecting the appearance of an object is then coated on the surface of the plastic material. In particular, according to the present invention, it is preferred that the integrated minor 100 be formed by an injection molding process, in which the blind zone minor 102 and the outside minor 104 are injection molded to form an integrated structure.

Preferably, the integrated minor 100 is configured with a plastic body and a layer coated with reflective material. Any suitable type of material may be used as each of the plastic material for integrally molding the blind zone minor and the outside minor and the reflective material for reflecting the appearance of an object.

For example, the integrated minor 100 may be manufactured by using a UV hard coating layer for preventing discoloration of polycarbonate (PC), a first SiO₂ coating layer for improving coating adhesion, a chrome coating layer for a reflection surface on which an object is reflected, and a second SiO₂ coating layer for increasing the durability of chrome coating are sequentially coated on the surface of the body made of a PC material.

Particularly, a dust cover 106 is vertically bent toward the rear (i.e., in the front direction of a vehicle), the dust cover 106 being integrally formed with a frame of the integrated minor 100.

Preferably, when the blind zone minor 102 and the outside minor 104 are integrally injection-molded using the plastic material, the dust cover 106 is integrally molded with the frames of the blind zone minor 102 and the outside minor 104.

Thus, if the rear surface of the integrated mirror 100, which is integrally molded with the blind zone minor 102 and the outside minor 104, is adhered to a front surface of a holder 110 by a medium such as a double-faced adhesive tape 120, the dust cover 106 of the integrated minor 100 surrounds the circumferential surface of the holder 110.

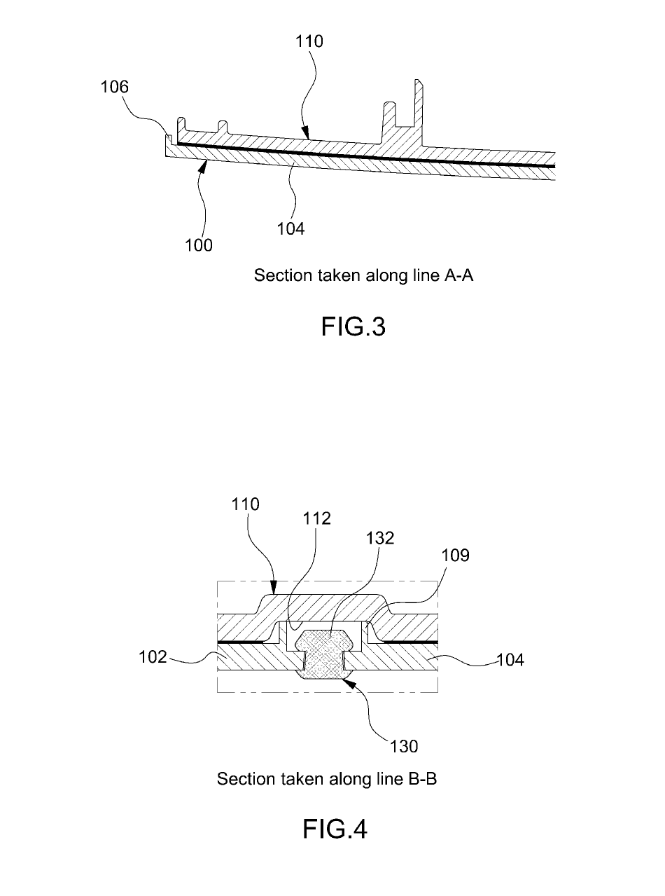

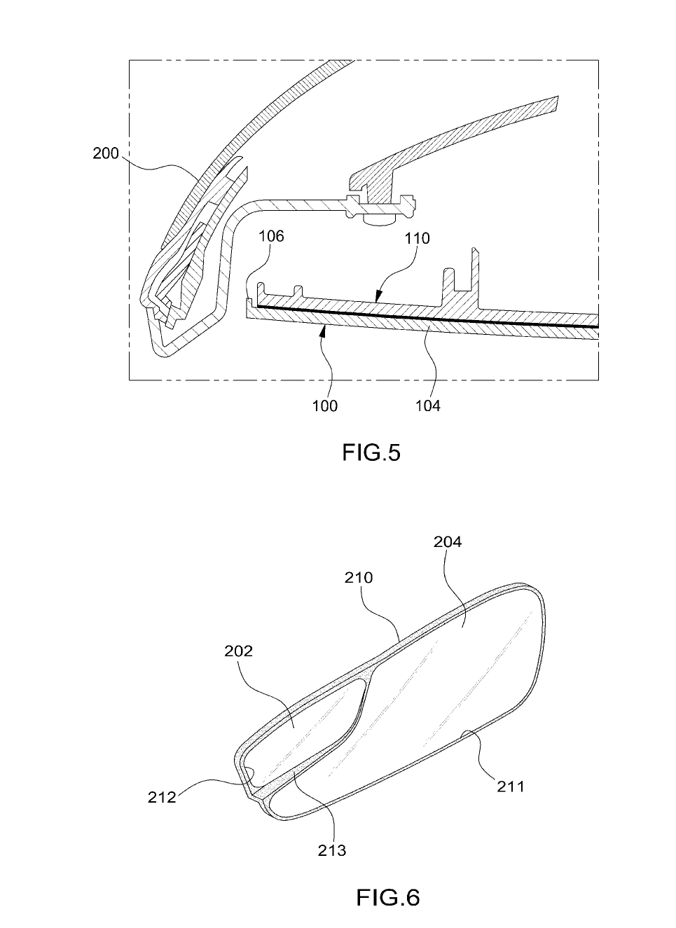

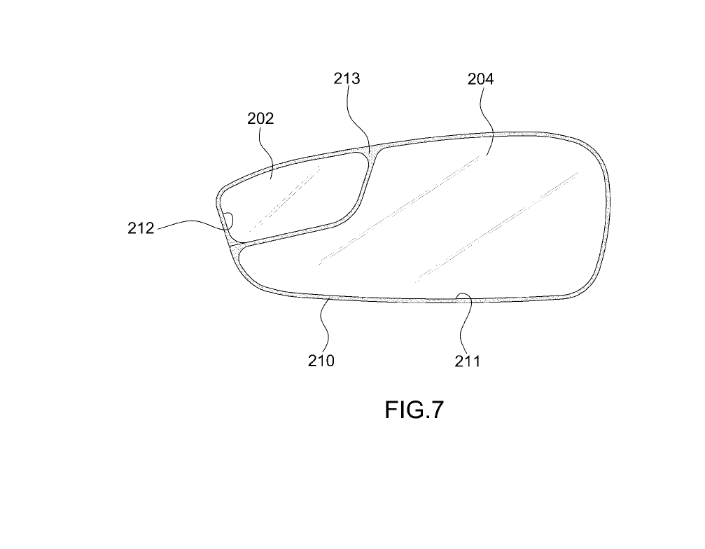

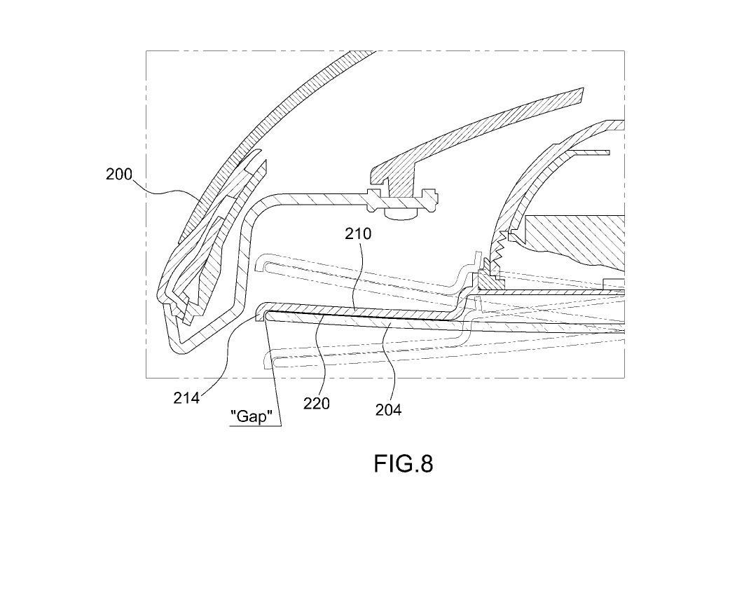

Thus, as shown in FIGS. 3 and 5, a gap between the integrated minor 100 and the holder 110 is never exposed to the outside of the body, so that it is possible to prevent various kinds of foreign matter such as dust and other contaminants from penetrating into the gap between the integrated minor 100 and the holder 110. Accordingly, it is possible to maintain the adhesion of the double-face adhesive tape 120 by which the integrated minor 100 and the holder 110 are adhered to each other and to continuously maintain a state in which the integrated minor 100 is firmly adhered to the holder 110.

For reference, the holder 110 is integrally connected to an electric driving means (not shown) mounted in a body 200 of the outside minor assembly, so as to be movable in top, bottom, left and right directions when the driver's rear viewing angle is adjusted.

Preferably, as shown in FIGS. 1 to 3, a divider fastening groove 108 is formed at a boundary portion between the blind zone minor 102 and the outside minor 104 of the integrated minor 100.

More specifically, as the divider fastening groove 108 is formed in the shape of a concave groove, a rear surface of the divider fastening groove 108 is protruded. Accordingly, when being viewed from the rear of the integrated minor 100, a rear protruding portion 109 of the divider fastening groove 108 is integrally protruded.

In this case, a divider 130 for clearly distinguishing the blind zone minor 102 from the outside minor 104 is inserted and fastened into the divider fastening groove 108 of the integrated minor 100.

A hook 132 may be integrally formed on the rear surface of the divider 130 so that the divider 130 is firmly fastened to the integrated minor 100. For example, the hook 132 is inserted and fastened into the divider fastening groove 108, so that it is possible to firmly maintain the fastening force of the divider 130 to the integrated minor 100.

As described above, the separate divider 130 is inserted and fastened at the boundary portion between the blind zone minor 102 and the outside minor 104, so that the driver can clearly distinguish the blind zone minor 102 from the outside minor 104. Accordingly, the driver can clearly distinguish an object shown in the outside mirror 104 from an object in a blind zone or dead zone, which is shown in the blind zone mirror 102.

Meanwhile, a receiving groove 112 is formed at a portion corresponding to the divider fastening groove 108 of the integrated mirror 100 on the front surface of the holder 110, i.e., a portion corresponding to the rear protruding portion 109 protruded at the rear of the fastening groove 108, where the receiving groove 112 allows the rear protruding portion 109 to be inserted therein.

Thus, the rear surface of the integrated mirror 100 including the rear protruding portion 109 is adhered to the front surface of the holder 110 without any gap by a medium such as the double-faced adhesive tape 120, so that adhesion of the integrated mirror 100 to the holder 110 can be more firmly maintained.

Preferably, the dust cover 106 bent backward is integrally injection-molded with the frame of the integrated mirror 100 so as to surround the circumferential surface of the holder. Accordingly, it is possible to prevent the gap between the integrated mirror 100 and the holder 110 from being exposed to the outside, thereby blocking the penetration of external dust in advance.

In the conventional outside mirror assembly, as the blind zone mirror and the outside mirror are separately provided and adhered to the front surface of the holder, each of the blind zone mirror and the outside mirror forms a gap with the divider of the holder, which is exposed to the outside, thereby accelerating the penetration of external dust into the double-faced adhesive tape. However, in the integrated mirror of the present invention, the blind zone minor 102 and the outside minor 104 are integrally injection-molded so that the gap between the holder 110 and each of the blind zone minor 102 and the outside minor 104 cannot be formed, so that it is possible to more effectively block the penetration of external dust into the double-faced adhesive tape.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An outside minor assembly for a vehicle, comprising:
an integrated minor having a blind zone minor and an outside minor that are integrally injection-molded; and
a dust cover being bent backward and integrally formed with frames of the blind zone minor and the outside minor,
wherein, when the integrated minor is adhered to the front surface of a holder by a double-faced adhesive tape, the dust cover surrounds a circumferential surface of the holder.

2. The outside minor assembly of claim 1, wherein the integrated minor including the blind zone minor and the outside minor is formed by coating a reflective material for reflecting the appearance of an object on the surface of a body made of a plastic material.

3. The outside minor assembly of claim 2, wherein the integrated minor including the blind zone minor and the outside minor is formed by sequentially coating a UV hard coating layer, a first SiO₂ coating layer, a chrome coating layer and a second SiO₂ coating layer on the surface of the body made of a polycarbonate (PC) material.

4. The outside minor assembly of claim 1, wherein a divider fastening groove is formed at a boundary portion between the blind zone minor and the outside minor of the integrated minor, and a divider for distinguishing the blind zone minor from the outside minor is inserted and fastened into the divider fastening groove.

5. The outside mirror assembly of claim 3, wherein a hook is inserted and fastened into the divider fastening groove of the integrated minor, the hook being integrally formed on a rear surface of the divider.

6. The outside minor assembly of claim 4, further comprising a receiving groove formed at a portion corresponding to the divider fastening groove of the integrated minor on a front surface of the holder, the receiving groove configured to allow a rear protruding groove of the divider fastening groove to be inserted therein.

7. An outside minor assembly for a vehicle, comprising:
an integrated minor having a blind zone minor and an outside minor that are integrally injection-molded; and
a dust cover being bent backward and integrally formed with frames of the blind zone minor and the outside minor,
wherein, the integrated minor is adhered to the front surface of a holder and the dust cover surrounds a circumferential surface of the holder.
